(19) United States
(12) Patent Application Publication
(10) Pub. No.: US 2016/0105883 A1
(43) Pub. Date: Apr. 14, 2016

(54) SYSTEM AND METHOD FOR MOBILITY ENHANCED WI-FI ARCHITECTURE

(71) Applicant: Benu Networks, Inc., Billerica, MA (US)

(72) Inventor: Rajat GHAI, Sandwich, MA (US)

(21) Appl. No.: 14/881,994

(22) Filed: Oct. 13, 2015

Related U.S. Application Data
(60) Provisional application No. 62/063,200, filed on Oct. 13, 2014.

(51) Int. Cl. H04W 72/04; H04L 12/66

(52) U.S. Cl. CPC H04W 72/048; H04L 12/66; H04W 88/08

(57) ABSTRACT

Described herein are techniques for providing Wi-Fi services to a Wi-Fi enabled device, even when the device is not within range of a Wi-Fi Access Point. A Wi-Fi access gateway can establish a first connection with a Wi-Fi radio node across a first network, when the device is within range of the Wi-Fi radio node. The Wi-Fi access gateway can also receive first network traffic over the first connection, when the device is connected to the Wi-Fi radio node. The Wi-Fi access gateway can further establish a second connection with the cellular radio node across a second network, when the device is within range of the cellular radio node and when the device is outside of range of the Wi-Fi radio node. The Wi-Fi access gateway can also receive second network traffic over the second connection when the device is connected to the cellular radio node.

### RELATED APPLICATIONS

This application relates to and claims priority under 35 U.S.C. §119(e) to U.S. Provisional Patent Application No. 62/063,200, entitled “Wi-Fi Architecture,” which was filed on Oct. 13, 2014 and is hereby incorporated by reference herein in its entirety.

### FIELD

The subject matter disclosed in this application generally relates to centrally managed Wi-Fi systems and, more specifically, Wi-Fi systems with mobility enhanced Wi-Fi architectures.

### BACKGROUND

Less than a decade ago most people carried only one Wi-Fi enabled device—a Wi-Fi enabled laptop. Since then, what is often referred to as the Wi-Fi revolution has taken the world by storm. According to Wi-Fi Alliance, there were approximately 1.1 Billion Wi-Fi enabled devices shipped in 2012 alone. With the proliferation of Wi-Fi enabled smartphones, tablets, gaming consoles, and embedded household appliances like TVs, an average household has more than five Wi-Fi enabled devices at any given time. Wi-Fi devices support a number of vertical applications like health, fitness, smart energy, and the internet of things (IoT). These and other applications are anticipated to drive the total amount of Wi-Fi shipments per year to double to 2.2 Billion in 2016. One universal Wi-Fi spectrum and the rapid standardization and adoption cycle of Wi-Fi technologies such as 802.11 a/b/g/n/ac has made Wi-Fi the broadband wireless access of choice.

In parallel, cloud computing and associated cloud technologies are creating an information technology (IT) revolution of their own. The adoption of cloud technology was possible due to cheap long haul transmission capacity (often referred to as “fat pipes”), and the low cost of compute cycles and storage. Leveraging this trend, Wi-Fi and cloud technologies combined are expected to usher in a new era of ubiquitous networking and service availability.

Wi-Fi Access Points (APs) Radios are ubiquitous, which further enabled the proliferation of Wi-Fi enabled devices. According to the Wireless Broadband Alliance, the number of Wi-Fi network access points is expected to reach 5.8 million by 2015 (up from 1.3 million in 2011). Users can be in range of Wi-Fi APs most of their days, in their homes, their work, schools, or in public places with Wi-Fi hotspots. Almost ninety percent of a typical user's mobile life occurs over Wi-Fi APs. Wi-Fi technologies offer wider spectrum than cellular technologies and have a faster innovation cycle (typically two years) compared to cellular (typically five to seven years). However, users still have to rely on cellular technologies, when they are not in range of Wi-Fi APs, for example, when they commute to and from work or when they travel. Without a Wi-Fi AP in range, a Wi-Fi enabled device cannot connect to a Wi-Fi access gateway of their Wi-Fi service provider. Accordingly, there is a need for a mobility enhanced Wi-Fi Packet core that can enable a Wi-Fi enabled device to access a Wi-Fi access gateway and their subscriber services, even when the Wi-Fi enabled device is not in range of a Wi-Fi AP.

### SUMMARY

Given the proliferation of Wi-Fi enabled devices, it would be advantageous for service providers to be able to provide managed Wi-Fi services to their subscribers even when the user's Wi-Fi enabled device is not within range of a Wi-Fi AP. For example, if a user has started watching at home on his mobile phone a movie that he rented from his internet service provider, the user would prefer to continue watching the movie even after he left his home, e.g., while commuting to work, when he is not in range of his home Wi-Fi network, but rather is within the range of a cellular access point.

Disclosed subject matter includes, in one aspect, a computerized method for providing Wi-Fi services between a Wi-Fi access gateway and at least one of a first Wi-Fi radio node and a first cellular radio node, wherein the first Wi-Fi radio node and the Wi-Fi access gateway are connected across a first network, the first cellular radio node and the Wi-Fi access gateway are connected across a second network, and the Wi-Fi access gateway provides Wi-Fi services to a device connected to at least one of the first Wi-Fi radio node and the first cellular radio node. The method can comprise the steps of establishing, by the Wi-Fi access gateway, a first connection with the first Wi-Fi radio node across the first network, wherein the first Wi-Fi radio node is configured to connect to the device when the device is within range of the first Wi-Fi radio node and receiving, by the Wi-Fi access gateway, first network traffic over the first connection, wherein the first network traffic is associated with the Wi-Fi services for the device, when the device is connected to the first Wi-Fi radio node. The method can also comprise the steps of establishing, by the Wi-Fi access gateway, a second connection with the first cellular radio node across the second network, wherein the first cellular radio node is configured to connect to the device when the device is within range of the first cellular radio node and when the device is outside of range of the first Wi-Fi radio node, and receiving, by the Wi-Fi access gateway, second network traffic over the second connection when the device is connected to the first cellular radio node, wherein the second network traffic is associated with the Wi-Fi services for the device.

Disclosed subject matter includes, in another aspect, a computing system for providing Wi-Fi services between a Wi-Fi access gateway and at least one of a first Wi-Fi radio node and a first cellular radio node, wherein the first Wi-Fi radio node and the Wi-Fi access gateway are connected across a first network, the first cellular radio node and the Wi-Fi access gateway are connected across a second network, and the Wi-Fi access gateway provides Wi-Fi services to a device connected to at least one of the first Wi-Fi radio node and the first cellular radio node. The Wi-Fi access gateway comprises a processor that can be configured to establish a first connection with the first Wi-Fi radio node across the first network, wherein the first Wi-Fi radio node is configured to connect to the device when the device is within range of the first Wi-Fi radio node and receive first network traffic over the first connection, wherein the first network traffic is associated with the Wi-Fi services for the device, when the device is connected to the first Wi-Fi radio node. The processor can be further configured to establish a second connection with the first cellular radio node across the second network, wherein the first cellular radio node is configured to connect to the device when the device is within range of the first cellular radio node and when the device is outside of range of the first Wi-Fi radio node and receive second network traffic over the second connection when the device is connected to the first cellular radio node, wherein the second network traffic is associated with the Wi-Fi services for the device.

Disclosed subject matter includes, in yet another aspect, a non-transitory computer readable medium comprising executable instructions operable to cause an apparatus to establish a first connection with a first Wi-Fi radio node across a first network, wherein the first Wi-Fi radio node is configured to connect to a device when the device is within range of the first Wi-Fi radio node and receive first network traffic over the first connection, wherein the first network traffic is associated with Wi-Fi services for the device, when the device is connected to the first Wi-Fi radio node. The executable instructions can further be operable to cause the apparatus to establish a second connection with a first cellular radio node across a second network, wherein the first cellular radio node is configured to connect to the device when the device is within range of the first cellular radio node and when the device is outside of range of the first Wi-Fi radio node and receive second network traffic over the second connection when the device is connected to the first cellular radio node, wherein the second network traffic is associated with the Wi-Fi services for the device.

Before explaining example embodiments consistent with the present disclosure in detail, it is to be understood that the disclosure is not limited in its application to the details of constructions and to the arrangements set forth in the following description or illustrated in the drawings. The disclosure is capable of embodiments in addition to those described and is capable of being practiced and carried out in various ways. Also, it is to be understood that the phraseology and terminology employed herein, as well as in the abstract, are for the purpose of description and should not be regarded as limiting.

These and other capabilities of embodiments of the disclosed subject matter will be more fully understood after a review of the following figures, detailed description, and claims.

It is to be understood that both the foregoing general description and the following detailed description are explanatory only and are not restrictive of the claimed subject matter.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings.

FIG. 1 illustrates an exemplary system for centrally managed Wi-Fi, according to some embodiments.

FIG. 2 illustrates an exemplary coverage system in an area with Wi-Fi and cellular coverage.

FIG. 3 illustrates an exemplary mobility enhanced system for centrally managed Wi-Fi, according to some embodiments.

FIG. 4 illustrates an exemplary message exchange for providing Wi-Fi services, according to some embodiments.

FIG. 5 illustrates an exemplary message exchange for providing Wi-Fi services, according to some embodiments.

FIG. 6 illustrates an exemplary message exchange for providing Wi-Fi services, according to some embodiments.

FIG. 7 illustrates an exemplary message exchange for providing Wi-Fi services, according to some embodiments.

FIG. 8 illustrates a flow diagram illustrating a computerized process for providing Wi-Fi services, according to some embodiments.

### DESCRIPTION

In the following description, numerous specific details are set forth regarding the systems and methods of the disclosed subject matter and the environment in which such systems and methods may operate, in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the disclosed subject matter. In addition, it will be understood that the embodiments described below are only examples, and that it is contemplated that there are other systems and methods that are within the scope of the disclosed subject matter.

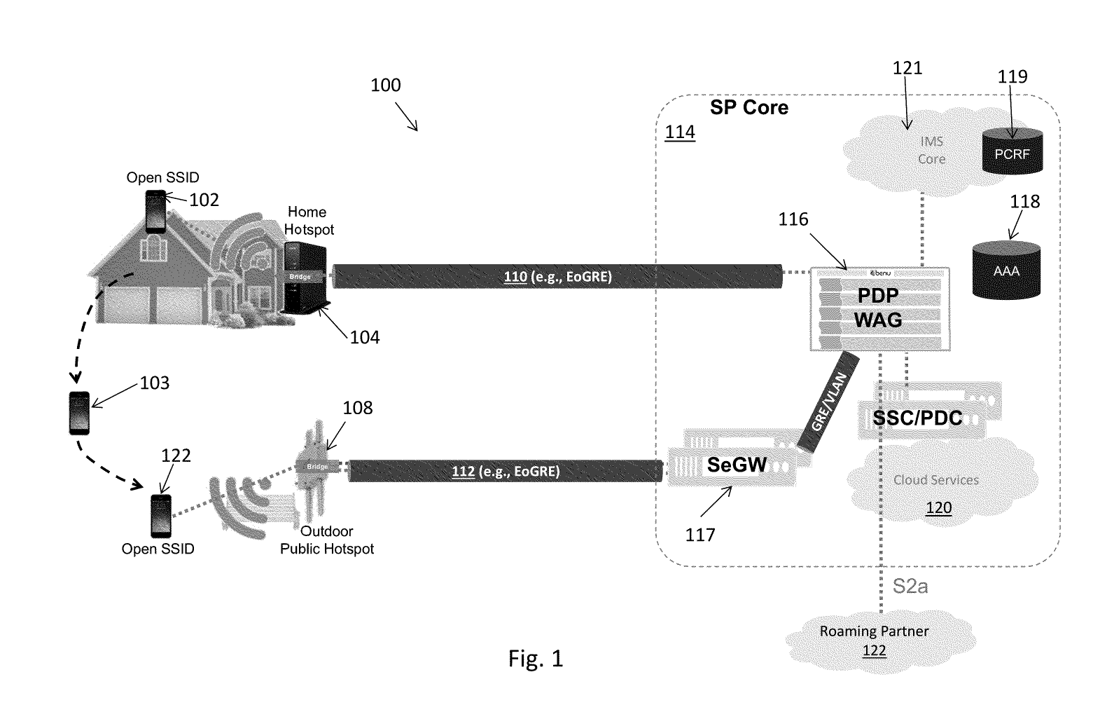

FIG. 1 shows an arrangement of two access points (AP) in a Wi-Fi network. Specifically, FIG. 1 shows a Wi-Fi hotspot network 100 in which a user can use a device 102, for example, a smartphone, to connect via Wi-Fi to a home hotspot Wi-Fi AP 104. The hotspot network also includes an outdoor public hotspot Wi-Fi AP 108, where one or more user devices 122 can connect to when they are within the range of the outdoor public hotspot Wi-Fi AP 108. The hotspot network 100 also includes Wi-Fi hotspot core network 114, for example, Comcast's “xfinity®” hotspot network, which can include a Policy Decision Point (PDP) Wi-Fi Access Gateway (WAG) 116, a Service Gateway (SeGW) 117, an authentication, authorization, and accounting (AAA) services database/server 118, Policy and Charging Rules Function (PCRF) node 119, cloud services 120, which can include for example, parental controls, content filtering, malware detection, and internet security, and IP Multimedia Subsystem (IMS) core (121). IMS provides a unified service architecture for different networks, leveraging the capabilities of IP. Home hotspot Wi-Fi AP 104 and outdoor public hotspot 108 can communicate with hotspot core network 114 via communication channels 110 and 112, respectively. Communication channels 110 and 112 can include any appropriate communication means, for example, Ethernet over Generic Routing Encapsulation (EoGRE). WAG 116 can also communicate with roaming partner network 122. A roaming network can include for example any network that a user can connect to when roaming in an area outside the coverage of his network. For example, when a Comcast “xfinity®” Wi-Fi customer goes to Europe, he can connect to a Wi-Fi network operating in Europe, for example, the Boingo Wi-Fi network.

Referring to Wi-Fi device 102, a Wi-Fi device 102 can include any type of device that can connect to both Wi-Fi and cellular, e.g., LTE, 3G, such as smartphones and tablets.

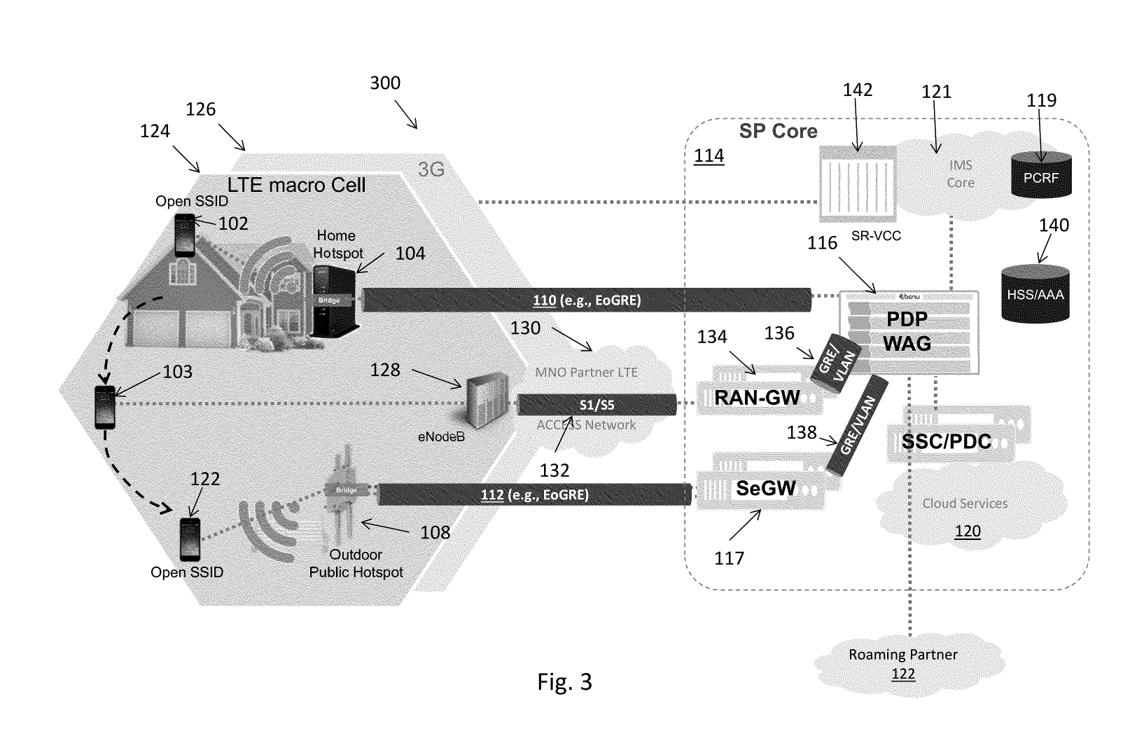

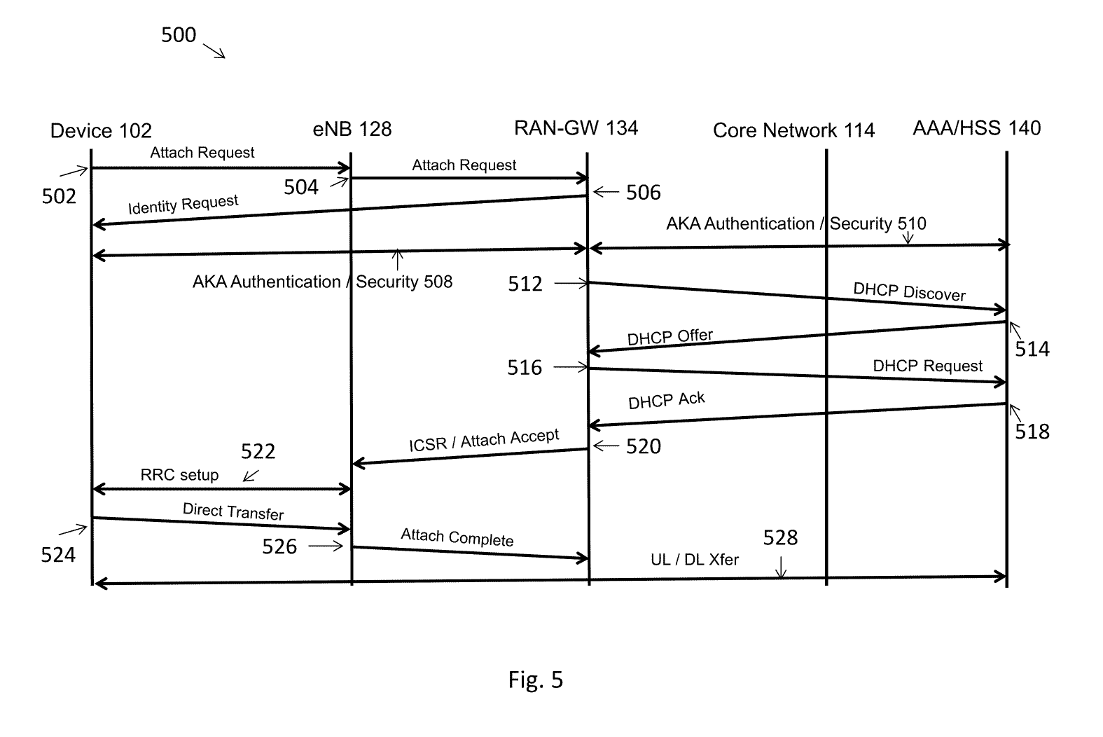

Referring to cloud services 112, the services can include, for example, cloud IP services. For example, cloud services 112 can include services that provide for sharing of digital media between multimedia devices. For example, the Digital Living Network Alliance (DLNA) provides guidelines for digital media sharing that specify a set of restricted ways of using the standards to achieve interoperability. The cloud services 112 can include video on demand services, as explained further herein with reference to FIG. 3. The cloud services 112 can include parental management controls, as explained further herein with reference to FIG. 5.

Wi-Fi access gateway 116 can include a processor configured to implement the functionality described herein using computer executable instructions stored in temporary and/or permanent non-transitory memory. The memory can be flash memory, a magnetic disk drive, an optical drive, a programmable read-only memory (PROM), a read-only memory (ROM), or any other memory or combination of memories. The processor can be a general purpose processor and/or can also be implemented using an application specific integrated circuit (ASIC), programmable logic array (PLA), field programmable gate array (FPGA), and/or any other integrated circuit. The Wi-Fi access gateway 116 can include a database that may also be flash memory, a magnetic disk drive, an optical drive, a programmable read-only memory (PROM), a read-only memory (ROM), or any other memory or combination of memories. The Wi-Fi access gateway 116 can execute an operating system that can be any operating system, including a typical operating system such as Windows, Windows XP, Windows 7, Windows 8, Windows Mobile, Windows Phone, Windows RT, Mac OS X, Linux, VXWorks, Android, Blackberry OS, iOS, Symbian, or other OSs.

In some embodiments, the WAG 116 can include one or more modules that can be implemented in software using the processor and/or the memory. In some embodiments, the modules stored on the processor and/or the memory can be configured to perform or cause the processor to perform the functionality described herein

Referring further to WAG 116, the WAG 116 can provide a data plane with radio nodes 104, 108. In some embodiments, WAG 116 is a highly scalable platform that implements data/traffic plane aggregation of switched Ethernet virtual domains over a wide geographical area, allowing WAG 116 to serve millions of devices. The WAG 116 can include connections to each of the radio nodes 104, such as a generic routing encapsulation (GRE) tunnel that encapsulates the Layer 2 traffic from Wi-Fi devices, served by a corresponding radio node.

In some embodiments, WAG 116 provides high performance point-to-point switched Layer 2 domain. In a classical OSI layered computer networking model, network mobility (e.g., for session persistence) is often quicker at lower layers, e.g. Ethernet (layer 2) as opposed to networking layer (L3) or application layer (L7). However, the lower layers are often more messaging intensive than higher layers. The techniques described herein provide for a wide area Layer 2 network, such that high-performance equipment is able to participate with exponentially large number of transactions per second (TPS) while still providing seamless mobility at the MAC layer (Ethernet Layer). For example, flat Layer 2 domains (e.g., also called broadcast domains) are usually geographically small by design. To create a wide area Layer 2 network, virtual networks can be created by creating Layer 2 tunnels such that two devices think that they can see each other directly, yet they are located remotely from each other. These tunnels (e.g., also called overlays) are point to point over a routed IP network. Under some embodiments, such tunnels are also called pseudo-wires.

In some embodiments, WAG 116 provides a high performance IP data/forwarding plane that can analyze, shape, forward, etc. IP traffic from end Wi-Fi devices. As alluded to above, Layer 2 domains are often very messaging intensive, which is why they are often limited to a small geographical area serving a small set of devices on a Ethernet segment. However, by creating large wide area Layer 2 networks, the techniques described herein can support processing a tremendous number (e.g., hundreds of millions) of packets/frames per second by using wide area Layer 2 networks. Dense aggregation at the WAG 116 with a high performance forwarding plane (e.g., packet processing) allows service providers to, for example, inspect, and inject cloud-based bespoke data services (e.g. content filtering and parental control).

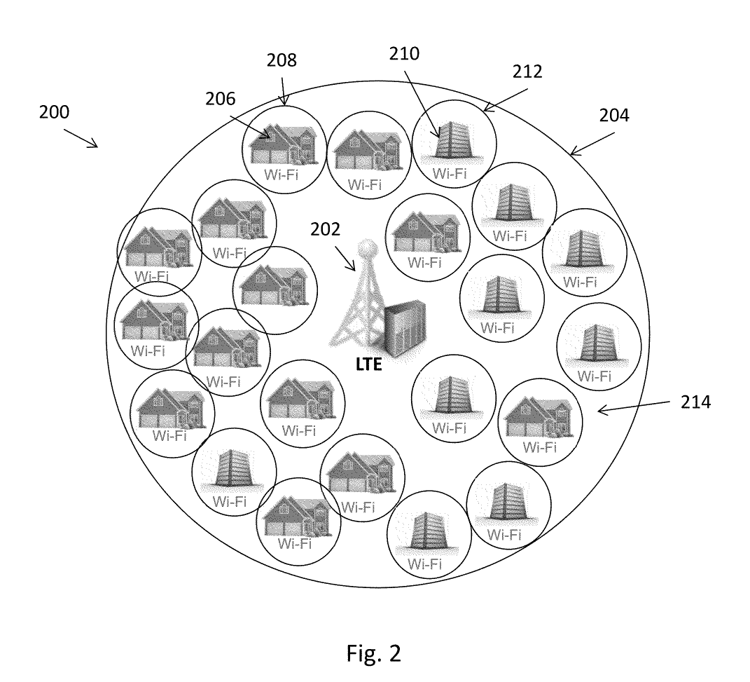

In the arrangement illustrated in FIG. 1, when a user leaves his home and he is outside the range (103) of his home Wi-Fi hotspot, he can no longer be connected to core network 114. The user may connect to another network, e.g., a cellular network, however, he may not be receiving the services he subscribed to with his service provider, e.g., Comcast, that operates core network 114. FIG. 2 illustrates an exemplary coverage system 200 in an area with Wi-Fi and cellular coverage. Specifically, the area has a cellular base station 202, e.g., an LTE base station (E-UTRAN Node B or eNodeB), with a cell area range identified by perimeter 204. The area also has multiple home Wi-Fi hotspots 206, each with a range identified by perimeter 208, and multiple public Wi-Fi hotspots 210, each with a range identified by perimeter 212. When the user roams within the coverage of a Wi-Fi hotspot, either home or public, the user's Wi-Fi enabled device can hop among the different hotspots and continue to be connected to the hotspot core network. However, as illustrated in FIG. 2, there can be areas within the range of the cellular base station 202, which are not within the range of any of the Wi-Fi hotspots 214. When the user is within areas where there is no Wi-Fi coverage, his Wi-Fi enabled device, e.g., his smartphone, will only be connected to the cellular network, e.g., the LTE network, through cellular base station 202. In that case, the Wi-Fi enabled device cannot connect to core network 114. The user can be within range of more than one cellular networks, e.g., AT&T and Verizon. According to embodiments of the present invention, the Wi-Fi enabled device can select one cellular network based on priorities established by WAG 116. According to embodiments of the present invention, when the user is within areas where there is both Wi-Fi coverage and LTE coverage, his Wi-Fi enabled device, will be connected to the Wi-Fi hotspot. According to alternative embodiments of the present invention, the Wi-Fi enabled device can select one Wi-Fi network when there is more than one available Wi-Fi networks based on priorities established by WAG 116.

The components of system 100 can include additional interfaces (not shown) that can allow the components to communicate with each other and/or other components, such as other devices on one or more networks, server devices on the same or different networks, or user devices either directly or via intermediate networks. The interfaces can be implemented in hardware to send and receive signals from a variety of mediums, such as optical, copper, and wireless, and in a number of different protocols, some of which may be non-transient.

System 100 can include a controller for managing the APs in a hotspot network, such as Comcast's “xfinity®” hotspot network. A management system that can be implemented in a cloud service running in a data center can connect to every hotspot Wi-Fi AP of a particular hotspot network and can automatically manage and configure the hotspot Wi-Fi APs to efficiently utilize the hotspot resources. Such system is described in U.S. patent application Ser. No. 14/625,301, entitled, “CLOUD CONTROLLER FOR SELF-OPTIMIZED NETWORKS,” filed on Feb. 18, 2015, the contents of which are incorporated herein in their entirety. Other components of system 100 and additional functions and services provided by WAG 116 are described in U.S. patent application Ser. No. 14/703,516, entitled “CONTENT AWARE WI-FI QoS,” filed on May 4, 2015, the content of which are also incorporated herein in their entirety.

According to embodiments of the present invention, FIG. 3 illustrates an exemplary system that enables a Wi-Fi enabled device to connect to core network 114, even when the Wi-Fi enabled device is not within range of a Wi-Fi hotspot. Specifically, FIG. 3 shows network 300, which can include the Wi-Fi hotspot network 100. FIG. 3 also shows Wi-Fi enabled device 103 in a wireless cell, e.g., LTE macro cell 124 and/or 3G 126. For example, Wi-Fi enabled device 103 is connected to an LTE cellular network through eNodeB 128, e.g., AT&T's LTE network, which can be a mobile network operator (MNO) partner of the operator of core network 114. eNodeB 128 can connect to the core network 114 through communication channel 132, e.g., using interfaces such as S1/S5. Communication channel 132 can connect eNodeB 128 with radio access network (RAN) gateway 134. Within the core network 114, RAN gateway 134 can connect to gateway 116 through communication channel 136, e.g., GRE/VLAN, and service gateway 117 can connect to gateway 116 through communication channel 136, e.g., GRE/VLAN. In network 300, WAG 116 can interact with the AAA server using subscriber information provided by the Home Subscriber Server (HSS) 140. Core network 114 can also implement Single Radio Voice Call Continuity (SR-VCC) functionality 142, as shown in FIG. 3.

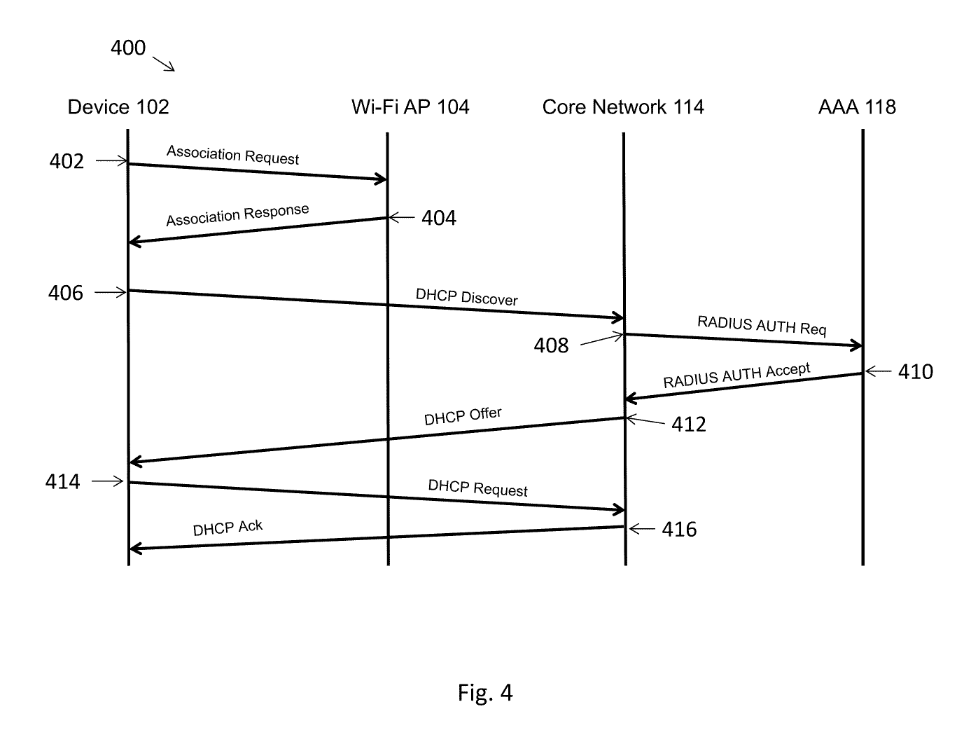

According to embodiments of the present invention, FIG. 4 illustrates an exemplary message exchange 400 when a Wi-Fi enabled device connects to the core network 114. Specifically, Wi-Fi enabled device 102 can send an association request 402 to Wi-Fi AP 104, which responds with an association response 404. When device 102 receives the association response from Wi-Fi AP 104, it can send a Dynamic Host Configuration Protocol (DHCP) Discover message 406 to core network 114. When core network 114 receives the DHCP Discover message 406, it can send RADIUS Authorization request 408 to AAA server 118, which can respond with RADIUS Authorization Accept message 410. When core network 114 receives RADIUS Authorization Accept message 410, it can send DHCP Offer message 412 to device 102. Device 102 can then send to core network 114 DHCP request 414, and core network 114 can send DHCP Ack message 416 to device 102. When device 102 receives DHCP Ack message 416, it is associated with core network 114.

According to embodiments of the present invention, FIG. 5 illustrates an exemplary message exchange 500 when a Wi-Fi enabled device, which can also communicate with a cellular network, connects to Wi-Fi core network 114 via eNodeB 128 of LTE network 130. Specifically, Wi-Fi enabled device 102 can send Attach Request 502 to eNodeB 128. When eNodeB 128 receives Attach Request 502, it can forward Attach Request 504 to radio access network (RAN) gateway 134. RAN gateway 134 can then send Identity Request 506 to device 102. When device 102 receives the Identity Request 506, a message exchange (Authentication and Key Agreement/Security message exchange) 508 can start between device 102 and RAN gateway 134, that can identify and authenticate device 102. In addition, there is also an Authentication and Key Agreement/Security message exchange 510 between RAN gateway 134 and AAA/HSS server 140. RAN gateway 134 can also send DHCP Discover message 512 to AAA/HSS server 140. When AAA/HSS server 140 receives the DHCP Discover message 512, it can send DHCP Offer message 514 to RAN gateway 134, which can then send to AAA/HSS server 140 DHCP request 516, and AAA/HSS server 140 can send DHCP Ack message 518 to RAN gateway 134. When to RAN gateway 134 receives DHCP Ack message 518, it can send ICSR/Attach Accept message 520 to eNodeB 128. When eNodeB 128 receives ICSR/Attach Accept message 520, RRC setup 522 can initiate between device 102 and eNodeB 128. Once the setup completes, device 102 can send Direct Transfer request 524 to eNodeB 128, which can send Attach Complete message 526 to RAN gateway 134. When RAN gateway 134 receives Attach Complete message 526, then upload and download transfers 528 can commence between device 102 and core network 114, through eNodeB 128.

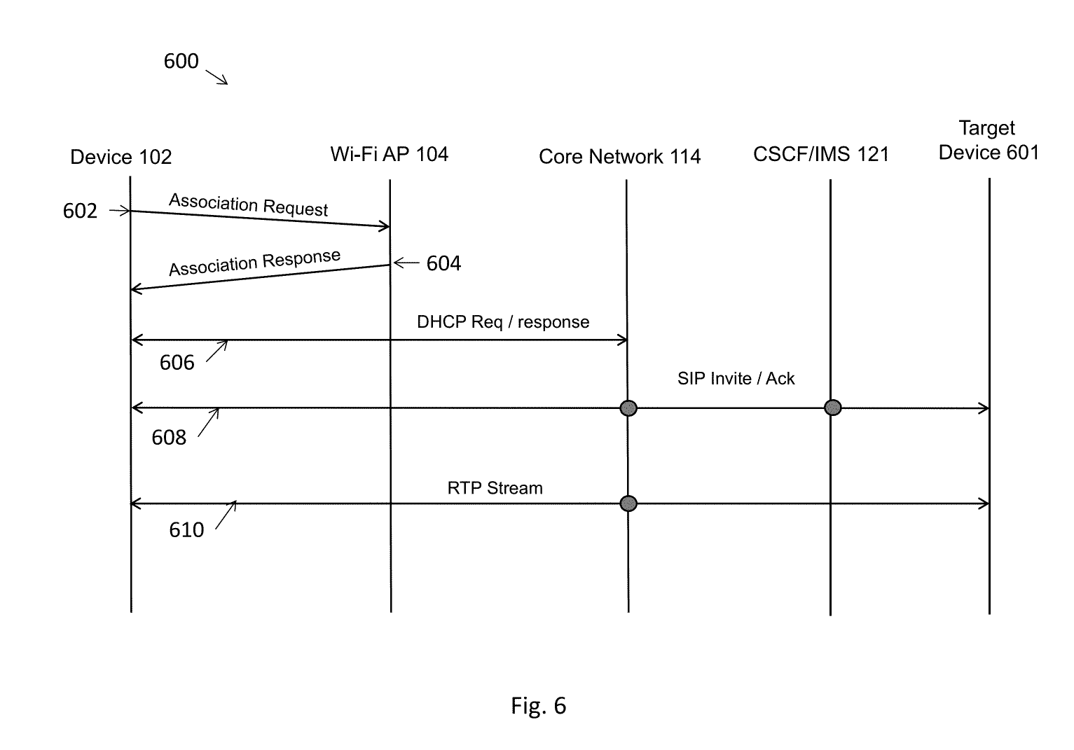

According to embodiments of the present invention, FIG. 6 illustrates an exemplary message exchange 600 when a Wi-Fi enabled device 102 connects to Wi-Fi core network 114 to implement Voice over IMS to connect to target device 601 through a trusted Wi-Fi network. Specifically, Wi-Fi enabled device 102 can send an association request 602 to Wi-Fi AP 104, which responds with an association response 604. When device 102 receives the association response from Wi-Fi AP 104, it can start DHCP message exchange 606 with core network 114. When the DHCP exchange 606 completes and core network 114 has assigned an IP address to device 102, device 102 can start a message exchange 608 to connect to target device 601. Specifically, device 102 can send a session initiation protocol (SIP) invite message to core network 114, which can be relayed to CSCF/IMS 121, and then to target device 601. Target device 601 can respond sending an SIP acknowledge message to device 102. Then a Real-time Transport Protocol (RTP) stream 610 can commence between device 102 and target device 601, through core network 114.

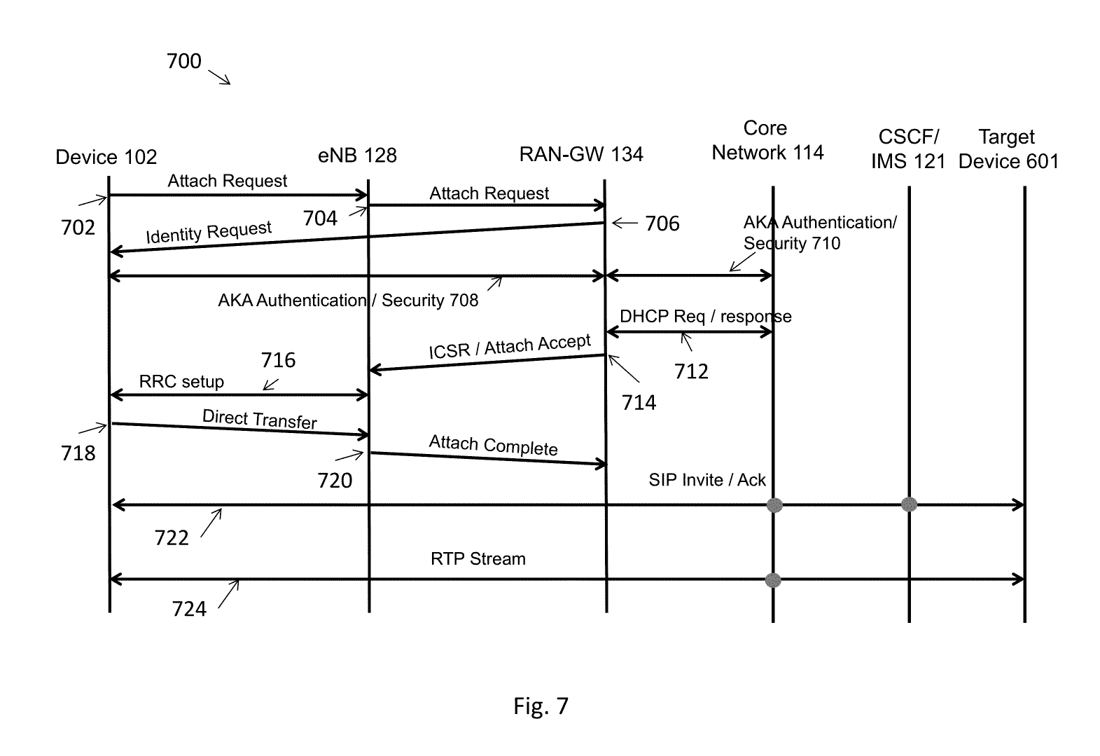

According to embodiments of the present invention, FIG. 7 illustrates an exemplary message exchange 700 when a Wi-Fi enabled device, which can also communicate with a cellular network, to Wi-Fi core network 114 to implement Voice over IMS to connect to target device 601 via eNodeB 128 of LTE network 130. Specifically, Wi-Fi enabled device 102 can send Attach Request 702 to eNodeB 128. When eNodeB 128 receives Attach Request 702, it can forward Attach Request 704 to radio access network (RAN) gateway 134. RAN gateway 134 can then send Identity Request 706 to device 102. When device 102 receives the Identity Request 706, a message exchange (Authentication and Key Agreement/Security message exchange) 708 can start between device 102 and RAN gateway 134, that can identify and authenticate device 102. In addition, there is also an Authentication and Key Agreement/Security message exchange 710 between RAN gateway 134 and core network 114. After the authentication session completes, a DHCP exchange between RAN gateway 134 and core network 114 can assign an IP address to device 102. RAN gateway 134 can then send an ICSR/Attach Accept message 714 to eNodeB 128, which can then communication with device 102 for RRC setup 716. Device 102 can send direct transfer message 718 to eNodeB 128, which in turn can send an attach complete 720 message to RAN gateway 134. Then device 102 can start a message exchange 722 to connect to target device 601. Specifically, device 102 can send a session initiation protocol (SIP) invite message to core network 114, which can be relayed to CSCF/IMS 121, and then to target device 601. Target device 601 can respond sending an SIP acknowledge message to device 102. Then a Real-time Transport Protocol (RTP) stream 724 can commence between device 102 and target device 601, through core network 114.

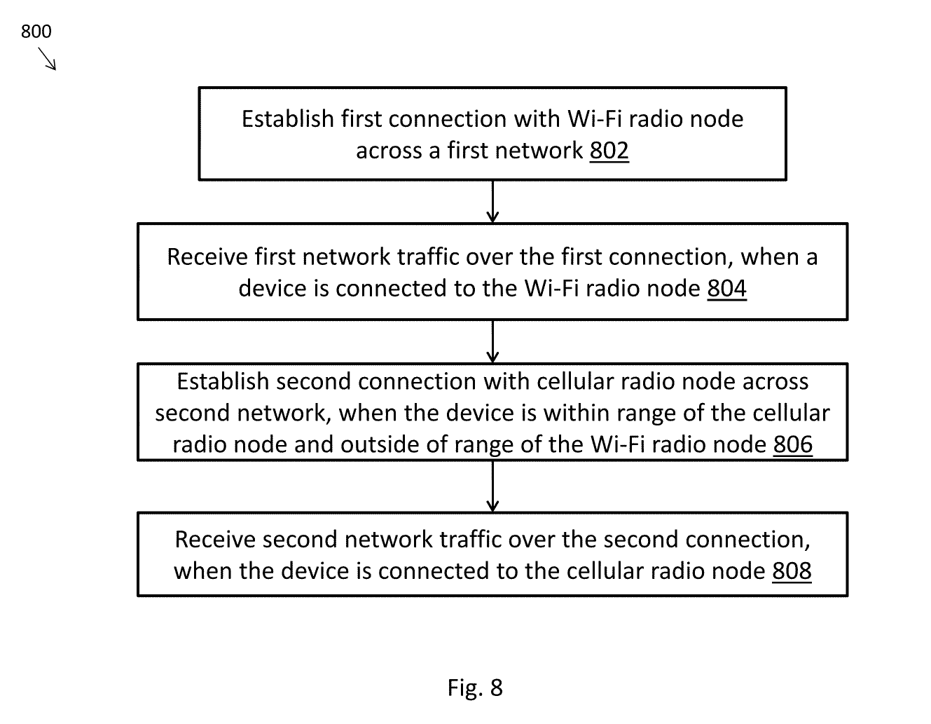

FIG. 8 shows an exemplary computerized method 800 for providing Wi-Fi services using connections between a Wi-Fi access gateway and a Wi-Fi enabled device, which can also connect to cellular networks. Specifically, the Wi-Fi access gateway can establish a first connection with the Wi-Fi radio node across a first network 802, when the device is within range of the Wi-Fi radio node. The Wi-Fi access gateway can also receive first network traffic over the first connection, when the device is connected to the Wi-Fi radio node 804. The Wi-Fi access gateway can further establish a second connection with the cellular radio node across a second network, when the device is within range of the cellular radio node and when the device is outside of range of the Wi-Fi radio node 806. The Wi-Fi access gateway can also receive second network traffic over the second connection when the device is connected to the cellular radio node 808. The handover from the first connection to the second connection can be done is a seamless fashion, such that the user of the Wi-Fi enabled device does not experience any disruption in the Wi-Fi services.

According to embodiments of the present invention, when the Wi-Fi enabled device is back in range of a Wi-Fi radio node, it can terminate the second connection, and can connect to the Wi-Fi access gateway through the Wi-Fi radio node. The handover back to the Wi-Fi radio node can be done is a seamless fashion. According to embodiments of the present invention, when the Wi-Fi enabled device is in range of both a Wi-Fi radio node and a cellular radio node, the Wi-Fi device can select which radio node to connect to, based on various criteria, such as available bandwidth, quality of service parameters, history of mobility, battery life and others.

While the techniques described herein describe in some embodiments using the techniques over a set of radio nodes in communication with a WAG, one of skill in the art can appreciate that the resulting network created can include a single network or combination of networks. For example, the network can include a local area network (LAN), a cellular network, a telephone network, a computer network, a private packet switching network, a line switching network, a wide area network (WAN), and/or any number of networks. Such networks may be implemented with any number of hardware and software components, transmission media and network protocols.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and systems for carrying out the several purposes of the disclosed subject matter. It is important, therefore, that the claims be regarded as including such equivalent constructions insofar as they do not depart from the spirit and scope of the disclosed subject matter.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter, which is limited only by the claims which follow.

A “server,” “client,” “agent,” “module,” “interface,” and “host” is not software per se and includes at least some tangible, non-transitory hardware that is configured to execute computer readable instructions. In addition, the phrase “based on” does not imply exclusiveness—for example, if X is based on A, X can also be based on B, C, and/or D.

What is claimed is:

1. A computerized method for providing Wi-Fi services between a Wi-Fi access gateway and at least one of a first Wi-Fi radio node and a first cellular radio node, wherein the first Wi-Fi radio node and the Wi-Fi access gateway are connected across a first network, the first cellular radio node and the Wi-Fi access gateway are connected across a second network, and the Wi-Fi access gateway provides Wi-Fi services to a device connected to at least one of the first Wi-Fi radio node and the first cellular radio node, comprising:
establishing, by the Wi-Fi access gateway, a first connection with the first Wi-Fi radio node across the first network, wherein the first Wi-Fi radio node is configured to connect to the device when the device is within range of the first Wi-Fi radio node;
receiving, by the Wi-Fi access gateway, first network traffic over the first connection, wherein the first network traffic is associated with the Wi-Fi services for the device, when the device is connected to the first Wi-Fi radio node;
establishing, by the Wi-Fi access gateway, a second connection with the first cellular radio node across the second network, wherein the first cellular radio node is configured to connect to the device when the device is within range of the first cellular radio node and when the device is outside of range of the first Wi-Fi radio node; and
receiving, by the Wi-Fi access gateway, second network traffic over the second connection when the device is connected to the first cellular radio node, wherein the second network traffic is associated with the Wi-Fi services for the device.

2. The method of claim 1, wherein the Wi-Fi access gateway establishes the second connection with the first cellular radio node through a radio access network gateway.

3. The method of claim 1, further comprising:
establishing, by the Wi-Fi access gateway, a third connection with a second Wi-Fi radio node across a third network, wherein the second Wi-Fi radio node is configured to connect to the device when the device is within range of the second Wi-Fi radio node; and
receiving, by the Wi-Fi access gateway, third network traffic over the third connection when the device is connected to the second Wi-Fi radio node, wherein the third network traffic is associated with the Wi-Fi services for the device.

4. The method of claim 3, further comprising pausing the second network traffic over the second connection, when the third connection is established.

5. The method of claim 1, wherein the first cellular radio node is at least one of a long term evolution (LTE) radio node and a third generation (3G) radio node.

6. The method of claim 1, further comprising selecting the first cellular radio node among a plurality of candidate cellular radio nodes.

7. The method of claim 1, wherein the Wi-Fi access gateway prioritizes the first connection over the second connection.

8. A computing system for providing Wi-Fi services between a Wi-Fi access gateway and at least one of a first Wi-Fi radio node and a first cellular radio node, wherein the first Wi-Fi radio node and the Wi-Fi access gateway are connected across a first network, the first cellular radio node and the Wi-Fi access gateway are connected across a second network, and the Wi-Fi access gateway provides Wi-Fi services to a device connected to at least one of the first Wi-Fi radio node and the first cellular radio node, wherein the Wi-Fi access gateway comprises a processor configured to:
establish a first connection with the first Wi-Fi radio node across the first network, wherein the first Wi-Fi radio node is configured to connect to the device when the device is within range of the first Wi-Fi radio node;
receive first network traffic over the first connection, wherein the first network traffic is associated with the Wi-Fi services for the device, when the device is connected to the first Wi-Fi radio node;
establish a second connection with the first cellular radio node across the second network, wherein the first cellular radio node is configured to connect to the device when the device is within range of the first cellular radio node and when the device is outside of range of the first Wi-Fi radio node; and
receive second network traffic over the second connection when the device is connected to the first cellular radio node, wherein the second network traffic is associated with the Wi-Fi services for the device.

9. The computing system of claim 8, wherein the processor is further configured to establish the second connection with the first cellular radio node through a radio access network gateway.

10. The computing system of claim 8, wherein the processor is further configured to:
establish a third connection with a second Wi-Fi radio node across a third network, wherein the second Wi-Fi radio node is configured to connect to the device when the device is within range of the second Wi-Fi radio node; and
receive third network traffic over the third connection when the device is connected to the second Wi-Fi radio node, wherein the third network traffic is associated with the Wi-Fi services for the device.

11. The computing system of claim 10, wherein the processor is further configured to pause the second network traffic over the second connection, when the third connection is established.

12. The computing system of claim 8, wherein the first cellular radio node is at least one of a long term evolution (LTE) radio node and a third generation (3G) radio node.

13. The computing system of claim 8, wherein the processor is further configured to select the first cellular radio node among a plurality of candidate cellular radio nodes.

14. The computing system of claim 8, wherein the processor is further configured to prioritize the first connection over the second connection.

15. A non-transitory computer readable medium comprising executable instructions operable to cause an apparatus to:
establish a first connection with a first Wi-Fi radio node across a first network, wherein the first Wi-Fi radio node is configured to connect to a device when the device is within range of the first Wi-Fi radio node;
receive first network traffic over the first connection, wherein the first network traffic is associated with Wi-Fi services for the device, when the device is connected to the first Wi-Fi radio node;
establish a second connection with a first cellular radio node across a second network, wherein the first cellular radio node is configured to connect to the device when the device is within range of the first cellular radio node and when the device is outside of range of the first Wi-Fi radio node; and
receive second network traffic over the second connection when the device is connected to the first cellular radio node, wherein the second network traffic is associated with the Wi-Fi services for the device.

16. The non-transitory computer readable medium of claim 15, wherein the executable instructions are further operable to cause the apparatus to establish the second connection with the first cellular radio node through a radio access network gateway.

17. The non-transitory computer readable medium of claim 15, wherein the executable instructions are further operable to cause the apparatus to:
establish a third connection with a second Wi-Fi radio node across a third network, wherein the second Wi-Fi radio node is configured to connect to the device when the device is within range of the second Wi-Fi radio node; and
receive third network traffic over the third connection when the device is connected to the second Wi-Fi radio node, wherein the third network traffic is associated with the Wi-Fi services for the device.

18. The non-transitory computer readable medium of claim 17, wherein the executable instructions are further operable to cause the apparatus to pause the second network traffic over the second connection, when the third connection is established.

19. The non-transitory computer readable medium of claim 15, wherein the first cellular radio node is at least one of a long term evolution (LTE) radio node and a third generation (3G) radio node.

20. The non-transitory computer readable medium of claim 15, wherein the executable instructions are further operable to cause the apparatus to select the first cellular radio node among a plurality of candidate cellular radio nodes.

21. The non-transitory computer readable medium of claim 15, wherein the executable instructions are further operable to cause the apparatus to prioritize the first connection over the second connection.
